(19) United States
(12) Patent Application Publication
(10) Pub. No.: US 2025/0218119 A1
(43) Pub. Date: Jul. 3, 2025

(54) CLOTHING DRAPING IN AN EXTENDED REALITY ENVIRONMENT

(71) Applicant: Meta Platforms Technologies, LLC, Menlo Park, CA (US)

(72) Inventor: Zohar Barzelay, Haifa (IL)

(21) Appl. No.: 18/977,745

(22) Filed: Dec. 11, 2024

Related U.S. Application Data
(60) Provisional application No. 63/615,728, filed on Dec. 28, 2023.

(51) Int. Cl. G06T 17/20; G06T 13/40; G06V 10/82

(52) U.S. Cl. CPC G06T 17/20; G06T 13/40; G06V 10/82

(57) ABSTRACT

As disclosed herein, a computer-implemented method for determining a garment mesh for an avatar is provided. The computer-implemented method may include receiving a pose of an avatar in an extended reality environment. The computer-implemented method may include receiving a garment of the avatar in the extended reality environment. The computer-implemented method may include receiving a pose parameter of the pose of the avatar. The computer-implemented method may include receiving a garment parameter of the garment of the avatar. The computer-implemented method may include providing the pose parameter and the garment parameter to a model configured to determine a garment mesh associated with a pose of an avatar for each garment type of a plurality of garment types. The computer-implemented method may include determining, via the model, a garment mesh associated with the garment and the pose. A system and a non-transitory computer-readable storage medium are also disclosed.

### CROSS REFERENCE TO RELATED APPLICATIONS

This present application claims the benefit of priority under 35 U.S.C. §119(e) to U.S. Provisional Application No. 63/615,728, filed Dec. 28, 2023, the disclosure of which is hereby incorporated by reference in its entirety for all purposes.

### BACKGROUND

### Field

The present disclosure generally relates to modeling realistic clothing movement. More particularly, the present disclosure relates to modeling a variety of garments for multiple avatars in an extended reality environment.

### Related Art

The evolution of digital avatars has transformed how individuals express themselves in extended reality environments. The realistic representation of clothing is a critical element of such expressions. Digital garments must not only fit an avatar accurately but also exhibit realistic movement and behavior. As users increasingly seek more personalized experiences, the demand for sophisticated clothing draping techniques that enhance the visual authenticity and interactivity of avatars has become paramount.

### SUMMARY

The subject disclosure provides for systems and methods for determining a garment mesh for an avatar in an extended reality (XR) environment, which may include a virtual reality (VR), an augmented reality (AR), or mixed reality (MR) environment. As disclosed herein, an XR environment may include a plurality of avatars. Each avatar may represent a user of a client device (e.g., a head-mounted display (HMD)) running an application that generates the extended reality environment. The client devices of the users may be connected via a network. For each frame of the XR environment, shape data, pose data, and garment data associated with an avatar may be determined. The application may transmit through the network the shape, pose, and garment data. The application may provide the shape, pose, and garment data for the plurality of avatars as inputs to an artificial intelligence (AI) model executing on a client device. For each garment type of an avatar, the AI model may determine as output a mesh, which may include a three-dimensional representation of a garment. For each avatar, the application may apply to the avatar a predicted mesh generated for the avatar.

According to certain aspects of the present disclosure, a computer-implemented method for determining a garment mesh for an avatar is provided. The computer-implemented method may include receiving a pose parameter of a pose of an avatar in an extended reality environment. The computer-implemented method may include receiving a garment parameter of a garment of the avatar in the extended reality environment. The computer-implemented method may include providing the pose parameter and the garment parameter to a model configured to determine a garment mesh associated with a pose of an avatar for each garment type of a plurality of garment types. The computer-implemented method may include determining, via the model, a garment mesh associated with the garment and the pose.

According to another aspect of the present disclosure, a system is provided. The system may include one or more processors. The system may include a memory storing instructions that, when executed by the one or more processors, cause the system to perform operations. The operations may include receiving a pose parameter of a pose of an avatar in an extended reality environment. The operations may include receiving a garment parameter of a garment of the avatar in the extended reality environment. The operations may include providing the pose parameter and the garment parameter to a model configured to determine a garment mesh associated with a pose of an avatar for each garment type of a plurality of garment types. The operations may include determining, via the model, a garment mesh associated with the garment and the pose.

According to yet other aspects of the present disclosure, a non-transitory computer-readable storage medium storing instructions encoded thereon that, when executed by a processor, cause the processor to perform operations, is provided. The operations may include receiving a pose parameter of a pose of an avatar in an extended reality environment. The operations may include receiving a garment parameter of a garment of the avatar in the extended reality environment. Receiving the garment parameter may include receiving pretrained data associated with the garment from an offline model. The operations may include providing the pose parameter and the garment parameter to a model configured to determine a garment mesh associated with a pose of an avatar for each garment type of a plurality of garment types. The operations may include determining, via the model, a garment mesh associated with the garment and the pose. The garment mesh may include a plurality of garment vertices including first location coordinates of the garment of the avatar in the extended reality environment. Determining the garment mesh associated with the garment and the pose may include determining a displacement of a garment vertex of the plurality of garment vertices with respect to a body vertex of a plurality of body vertices including second location coordinates of a body of the avatar in the extended reality environment. The operations may include rendering, based on the model, the garment mesh in the extended reality environment.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example environment suitable for determining a garment mesh for an avatar, according to some embodiments;

FIG. 2 is a block diagram illustrating details of an example client device and an example server from the example environment of FIG. 1, according to some embodiments;

FIG. 3 is a block diagram illustrating example operational blocks used in the example environment of FIG. 1, according to some embodiments;

FIG. 4 includes a flowchart illustrating operations in a method for determining a garment mesh for an avatar, according to some embodiments; and

FIG. 5 is a block diagram illustrating an exemplary computer system with which client devices, and the operations and methods in FIGS. 3 and 4, may be implemented, according to some embodiments.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive. Those skilled in the art may realize other elements that, although not specifically described herein, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

### General Overview

The evolution of digital avatars has transformed how individuals express themselves in extended reality environments, such as augmented reality (AR), virtual reality (VR), or mixed reality (MR) environments. The realistic representation of clothing is a critical element of such expressions. Digital garments must not only fit an avatar accurately but also exhibit realistic movement and behavior. As users increasingly seek more personalized experiences, the demand for sophisticated clothing draping techniques that enhance the visual authenticity and interactivity of avatars has become paramount.

Existing solutions for clothing draping for an object, such as an avatar, may include physics-based simulations that account for physical properties of a type of garment (e.g., the weight, stiffness, or elasticity of a fabric or a material of a garment; the cut or design of a garment, such as a pleated skirt) and that may be computationally expensive for real-time use. Other existing solutions may use neural networks, but these approaches also have drawbacks. For example, in an extended reality environment including an avatar for each of a plurality of users, if each system (e.g., head-mounted display (HMD)) for each user implements a neural network to predict and transmit garment mesh data, then network traffic may be significantly increased.

Moreover, existing solutions for clothing draping for an object, such as an avatar, may require a prediction model for each type of garment. A type of garment may include a style of garment designed for a particular purpose, occasion, or body part, or a type of garment may include a material of a garment. According to existing techniques, multiple serialized processing steps may be required. For example, initially, a shape vector representing body dimensions of an avatar (e.g., height, build, silhouette, proportion, head circumference, gender) may be provided to an artificial intelligence (AI) model for determining a garment mesh for the avatar in an extended reality (XR) environment. Based on the shape vector, the AI model may predict and output a garment mesh in a space defined by the XR environment, and the shape vector may be removed from the AI model. Next, a pose vector representing a posture, stance, position, or movement of the avatar (e.g., sitting, walking, kneeling, bowing, nodding, waving) may be provided to the AI model. Based on the pose vector, the AI model may predict and output an update to the garment mesh in the space defined by the XR environment, and the pose vector may be removed from the AI model. Finally, for a type of garment, a garment vector may be provided to the AI model. Based on the garment vector, the AI model may predict and output an update to the garment mesh in the space defined by the XR environment, and the garment vector may be removed from the AI model. In some existing solutions, the aforementioned process may be repeated for each pose and for each garment type, which may be time consuming and computationally cumbersome for an XR system. In some existing solutions, multiple AI models may be required to perform the aforementioned steps, wherein each of the multiple AI models may be trained to generate a garment mesh for a different garment type, which may be time consuming and computationally cumbersome for an XR system.

As disclosed herein, novel systems and methods represent a significant advancement in the field of avatar generation technology by providing for a unified artificial intelligence (AI) model that may predict draping for multiple garment types in real time. Herein, a garment may include an article of clothing, such as a shirt or dress, or a clothing accessory, such as a belt, necktie, scarf, necklace, or bracelet. Leveraging advancements in AI techniques, the AI model may recognize the geometric and physical properties of a garment and generate a highly detailed and accurate mesh conforming to the unique contours of an avatar. The methods and systems disclosed herein may implement batch processing to enable an AI model to predict a garment mesh for each of a plurality of garment types at the same time, rather than sequentially.

In some embodiments, an extended reality (XR) environment (e.g., a business meeting in a virtual reality (VR) environment, a retail store in an augmented reality (AR) environment) may include a plurality of avatars. An avatar, or an avatar body, may include a head, a neck, a torso, or a limb. Each avatar may represent a user of a client device (e.g., a head-mounted display (HMD)) running an application that generates the XR environment. The client devices may be communicatively coupled via a network.

For each avatar, one or more shape parameters, one or more pose parameters, and one or more garment parameters may be determined for each frame of the XR environment. A shape parameter may include a digital representation of an attribute that defines a form or structure of an avatar body (e.g., height, build, silhouette, proportion, head circumference, gender). A pose parameter may include a digital representation of a posture, stance, position, or movement of the avatar (e.g., sitting, walking, kneeling, bowing, nodding, waving). By way of non-limiting example, a pose parameter may include a positioning of the limbs of an avatar in a coordinate space (e.g., three-dimensional Cartesian coordinate system). A garment parameter may include a characteristic of a garment (e.g., category, material, condition, use). By way of non-limiting example, a garment parameter may include a category of a garment indicative of a purpose (e.g., modesty, protection, safety), occasion (e.g., formal, casual, graduation, wedding), or intended body part (e.g., t-shirt, blouse, blazer, jeans, skirt, tunic, cloak, head scarf, veil, hat, sneakers) of the garment. By way of another non-limiting example, a garment parameter may include a material of a garment (e.g., silk, cashmere, nylon, acrylic, velvet, denim, metal, plastic). By way of yet another non-limiting example, a garment parameter may include a condition of a garment (e.g., new, unworn, starched, wrinkled, frayed, faded, stained, warped). By way of yet another non-limiting example, a garment parameter may include a physical property of a garment (e.g., weight, stiffness, or elasticity of a fabric or a material of a garment).

To mitigate the computational requirements of currently existing solutions, the methods disclosed herein may allow the application to transmit through the network one or more shape parameters, one or more pose parameters, and one or more garment parameters associated with an avatar of a user of a client device. The application may generate a shape vector for the one or more shape parameters of the plurality of avatars. The application may generate a pose vector for the one or more pose parameters of the plurality of avatars. The application may generate a garment vector for the one or more garment parameters for the plurality of avatars. The garment vector may include a plurality of learned embeddings, wherein each learned embedding of the plurality of learned embeddings may correspond to a specific garment parameter (e.g., a garment category, such as t-shirt, or a garment material, such as cotton) or a movement associated with the specific garment parameter.

In some aspects of the embodiments, the learned embeddings may be received from an auxiliary model pretrained offline. In some aspects of the embodiments, the embeddings may be learned from physical simulation data that may define the movement of a garment type. In some further aspects of the embodiments, the physical simulation data may include one or more pretrained models. The one or more pretrained models used to learn an embedding of a garment type may further include a first pretrained model that provides data based on a category, style, or design of a garment (e.g., pants, shirt, jacket, shoes, tie, scarf), and a second pretrained model may provide data based on a material of the garment (e.g., denim pants, silk shirt, leather jacket, canvas shoes, silk tie, cashmere scarf). Other pretrained models may be considered that may provide additional data, such as velocity or acceleration data, to further enhance the embedding of the garment type, potentially operating in concert with a shape vector or a pose vector.

The application may provide, at inference, the shape, pose, and garment vectors as inputs to an artificial intelligence (AI) model (e.g., a machine learning (ML) model, such as a neural network) executing on a client device. The AI model may be configured to determine a garment mesh for each garment type of a plurality of garment types. For each garment type of an avatar, the AI model may determine as output a mesh, which may include a geometric three-dimensional representation of a garment. The mesh may include a plurality of vertices, edges, surfaces, or textures, which may be located in a space comprising the XR environment. In some aspects of the embodiments, a predicted mesh may be optimized by comparing the predicted mesh representing the movement of the garment on the avatar to the actual movement of the garment based on a movement of the garment that has been previously calculated. The previous calculation may come from previously stored data or from data used to train the AI model. For each avatar, the application may apply to the avatar a garment mesh generated for the avatar.

To mitigate the computational requirements of currently existing solutions, the methods disclosed herein may generate for a single AI model a garment-related input that may include data associated with a plurality of garment parameters (e.g., t-shirt, cotton, skirt, pleated). Some existing solutions may include only shape and pose as inputs, and the inputs may be provided to multiple AI models, each dedicated to a different garment type. Other existing solutions may include garment-related input, but inputs for a plurality of garment types may be provided to an AI model sequentially. Such existing solutions may be computationally inefficient for real-time clothing draping.

Moreover, the methods disclosed herein may implement batch processing, which may include providing a plurality of vectors (e.g., shape vector, pose vector, garment vector) as inputs to an AI model to predict a garment mesh. Using batch processing, the plurality of vectors may be processed by the AI model at the same time. In some embodiments, the plurality of vectors may be combined into a batch matrix (e.g., via concatenation, via multiplication). The batch matrix may be provided as input to an AI model to predict a garment mesh. In predicting the garment mesh using batch processing, fewer computations may be required than the number of computations required for sequential or successive processing, such as those of existing solutions.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments may be practiced without these specific details. In other instances, well known structures and devices are shown in block diagram form in order to facilitate a description thereof. The intention is to cover all modifications, equivalents, and alternatives consistent with the claimed subject matter.

### Example System Architecture

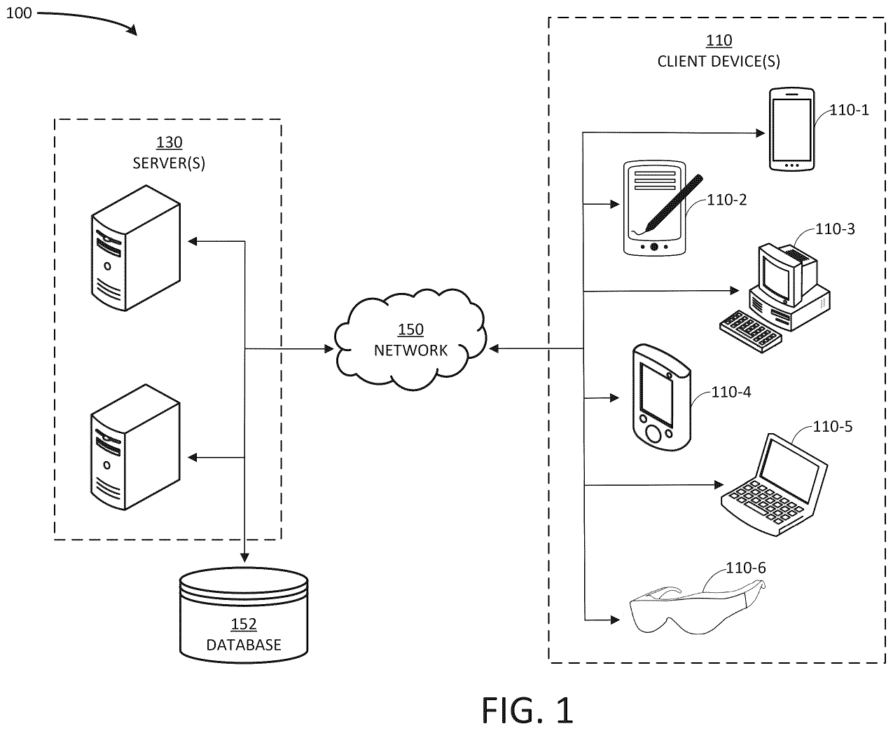

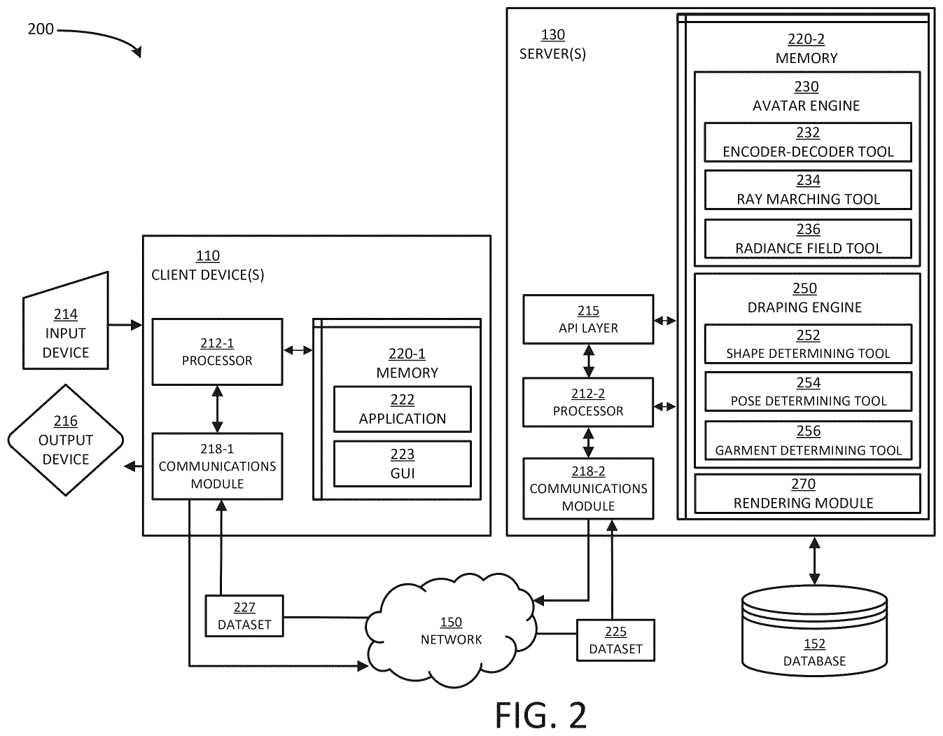

FIG. 1 illustrates an example environment 100 suitable for determining a garment mesh for an avatar, according to some embodiments. Environment 100 may include server(s) 130 communicatively coupled with client device(s) 110 and database 152 over a network 150. One of the server(s) 130 may be configured to host a memory including instructions which, when executed by a processor, cause server(s) 130 to perform at least some of the steps in methods as disclosed herein. In some embodiments, the processor may be configured to control a graphical user interface (GUI) for the user of one of client device(s) 110 accessing an avatar engine (e.g., avatar engine 230, FIG. 2)—which may include an encoder-decoder tool (e.g., encoder-decoder tool 232, FIG. 2), a ray marching tool (e.g., ray marching tool 234, FIG. 2), or a radiance field tool (e.g., radiance field tool 236, FIG. 2)—a draping engine (e.g., draping engine 250, FIG. 2)—which may include a shape determining tool (e.g., shape determining tool 252, FIG. 2), a pose determining tool (e.g., pose determining tool 254, FIG. 2), or a garment determining tool (e.g., garment determining tool 256, FIG. 2)—or a rendering module (e.g., rendering module 270). Accordingly, the processor may include a dashboard tool, configured to display components and graphic results to the user via a GUI (e.g., GUI 223, FIG. 2). For purposes of load balancing, multiple servers of server(s) 130 may host memories including instructions to one or more processors, and multiple servers of server(s) 130 may host a history log and database 152 including multiple training archives for the avatar engine-including the encoder-decoder tool, the ray marching tool, or the radiance field tool-the draping engine-including the shape determining tool, the pose determining tool, or the garment determining tool, or the rendering module. Moreover, in some embodiments, multiple users of client device(s) 110 may access the same avatar engine-including the encoder-decoder tool, the ray marching tool, or the radiance field tool-draping engine-including the shape determining tool, the pose determining tool, or the garment determining tool-or rendering module. In some embodiments, a single user with a single client device (e.g., one of client device(s) 110) may provide images and data (e.g., text) to train one or more artificial intelligence (AI) models running in parallel in one or more server(s) 130. Accordingly, client device(s) 110 and server(s) 130 may communicate with each other via network 150 and resources located therein, such as data in database 152.

Server(s) 130 may include any device having an appropriate processor, memory, and communications capability for an inside-out tracking module, an outside-in tracking module, a training module, or a rendering module. Any of the inside-out tracking module, the outside-in tracking module, the training module, or the rendering module may be accessible by client device(s) 110 over network 150.

Client device(s) 110 may include any one of a laptop computer 110-5, a desktop computer 110-3, or a mobile device, such as a smartphone 110-1, a palm device 110-4, or a tablet device 110-2. In some embodiments, client device(s) 110 may include a headset or other wearable device 110-6 (e.g., an extended reality (XR) headset, smart glass, or head-mounted display (HMD), including a virtual reality (VR), augmented reality (AR), or mixed reality (MR) headset, smart glass, or HMD), such that at least one participant may be running an extended reality application—including a virtual reality application, an augmented reality application, or mixed reality application—installed therein.

Network 150 may include, for example, any one or more of a local area network (LAN), a wide area network (WAN), the Internet, and the like. Further, network 150 may include, but is not limited to, any one or more of the following network topologies, including a bus network, a star network, a ring network, a mesh network, a star-bus network, tree or hierarchical network, and the like.

A user may own or operate client device(s) 110 that may include a smartphone device 110-1 (e.g., an IPHONE® device, an ANDROID® device, a BLACKBERRY® device, or any other mobile computing device conforming to a smartphone form). Smartphone device 110-1 may be a cellular device capable of connecting to a network 150 via a cell system using cellular signals. In some embodiments and in some cases, smartphone device 110-1 may additionally or alternatively use Wi-Fi or other networking technologies to connect to network 150. Smartphone device 110-1 may execute a client, Web browser, or other local application to access server(s) 130.

A user may own or operate client device(s) 110 that may include a tablet device 110-2 (e.g., an IPAD® tablet device, an ANDROID® tablet device, a KINDLE FIRE® tablet device, or any other mobile computing device conforming to a tablet form). Tablet device 110-2 may be a Wi-Fi device capable of connecting to a network 150 via a Wi-Fi access point using Wi-Fi signals. In some embodiments and in some cases, tablet device 110-2 may additionally or alternatively use cellular or other networking technologies to connect to network 150. Tablet device 110-2 may execute a client, Web browser, or other local application to access server(s) 130.

The user may own or operate client device(s) 110 that may include a laptop computer 110-5 (e.g., a MAC OS® device, WINDOWS® device, LINUX® device, or other computer device running another operating system). Laptop computer 110-5 may be an Ethernet device capable of connecting to a network 150 via an Ethernet connection. In some embodiments and in some cases, laptop computer 110-5 may additionally or alternatively use cellular, Wi-Fi, or other networking technologies to connect to network 150. Laptop computer 110-5 may execute a client, Web browser, or other local application to access server(s) 130.

FIG. 2 is a block diagram 200 illustrating example client device(s) 110 and example server(s) 130 from the environment of FIG. 1, according to some embodiments. Client device(s) 110 and server(s) 130 may be communicatively coupled over network 150 via respective communications modules 218-1 and 218-2 (hereinafter, collectively referred to as “communications modules 218”). Communications modules 218 may be configured to interface with network 150 to send and receive information, such as requests, responses, messages, and commands to other devices on the network in the form of datasets 225 and 227. Communications modules 218 may be, for example, modems or Ethernet cards, and may include radio hardware and software for wireless communications (e.g., via electromagnetic radiation, such as radiofrequency (RF), near field communications (NFC), Wi-Fi, or Bluetooth radio technology). Client device(s) 110 may be coupled with input device 214 and with output device 216. Input device 214 may include a keyboard, a mouse, a pointer, a touchscreen, a microphone, a joystick, a virtual joystick, and the like. In some embodiments, input device 214 may include cameras, microphones, and sensors, such as touch sensors, acoustic sensors, inertial motion units (IMUs), and other sensors configured to provide input data to an XR, AR, VR, or MR headset (or head-mounted display (HMD)). For example, in some embodiments, input device 214 may include an eye-tracking device to detect the position of a pupil of a user in an XR, AR, VR, or MR headset (or HMD). Likewise, output device 216 may include a display and a speaker with which the customer may retrieve results from client device(s) 110. Client device(s) 110 may also include processor 212-1, configured to execute instructions stored in memory 220-1, and to cause client device(s) 110 to perform at least some of the steps in methods consistent with the present disclosure. Memory 220-1 may further include application 222 and graphical user interface (GUI) 223, configured to run in client device(s) 110 and couple with input device 214 and output device 216. Application 222 may be downloaded by the user from server(s) 130 or may be hosted by server(s) 130. In some embodiments, client device(s) 110 may be an XR, AR, VR, or MR headset (or HMD) and application 222 may be an XR application, such as an AR, VR, or MR application. In some embodiments, client device(s) 110 may be a mobile phone used to collect a video or picture and upload to server(s) 130 using a video or image collection application (e.g., application 222), to store in database 152. In some embodiments, application 222 may run on any operating system (OS) installed in client device(s) 110. In some embodiments, application 222 may run out of a Web browser, installed in client device(s) 110.

Dataset 227 may include multiple messages and multimedia files. A user of client device(s) 110 may store at least some of the messages and data content in dataset 227 in memory 220-1. In some embodiments, a user may upload, with client device(s) 110, dataset 225 onto server(s) 130. Database 152 may store data and files associated with application 222 (e.g., one or more of datasets 225 and 227).

Server(s) 130 may include application programming interface (API) layer 215, which may control application 222 in each of client device(s) 110. Server(s) 130 may also include a memory 220-2 storing instructions which, when executed by processor 212-2, cause server(s) 130 to perform at least partially one or more operations in methods consistent with the present disclosure.

Processors 212-1 and 212-2 and memories 220-1 and 220-2 will be collectively referred to, hereinafter, as “processors 212” and “memories 220,” respectively.

Processors 212 may be configured to execute instructions stored in memories 220. In some embodiments, memory 220-2 may include avatar engine 230, draping engine 250, and rendering module 270. Avatar engine 230 may include encoder-decoder tool 232, ray marching tool 234, or radiance field tool 236. Draping engine 250 may include shape determining tool 252, pose determining tool 254, or garment determining tool 256. Avatar engine 230—including encoder-decoder tool 232, ray marching tool 234, or radiance field tool 236—draping engine 250-including shape determining tool 252, pose determining tool 254, or garment determining tool 256 or rendering module 270 may share or provide features or resources to GUI 223, including any tools associated with an extended reality application (e.g., application 222). A user may access avatar engine 230—including encoder-decoder tool 232, ray marching tool 234, or radiance field tool 236—draping engine 250—including shape determining tool 252, pose determining tool 254, or garment determining tool 256—or rendering module 270 through application 222, installed in a memory 220-1 of client device(s) 110. Accordingly, application 222, including GUI 223, may be installed by server(s) 130 and perform scripts and other routines provided by server(s) 130 through any one of multiple tools. Execution of application 222 may be controlled by processor 212-1.

Avatar engine 230 may be configured to create, store, update, or maintain an avatar model (e.g., a two-dimensional or three-dimensional avatar model), as disclosed herein. In some embodiments, avatar engine 230 may capture comprehensive data about a user (e.g., high-resolution RGB images, near-infrared (NIR) images, or other biometric data such as physical landmarks, voice patterns, or behavioral biometrics). Sensors and devices capable of capturing detailed biometric information may be utilized to ensure accuracy and completeness. The captured data may undergo processing to extract key features and characteristics of a user. The processing may include facial recognition algorithms to identify and map facial landmarks, or algorithms for extracting behavioral biometrics like gestures and voice patterns. Data encoding techniques may be applied to convert the extracted features into a standardized format suitable for storage and comparison, which may ensure an avatar model is compact, secure, and optimized for efficient retrieval and processing. An avatar may be designed to be comprehensive and invariant to normal variations in appearance and behavior while reflecting the unique attributes that distinguish a user.

An avatar may be securely stored in a centralized database or a distributed storage system. Security measures such as encryption, access controls, and data integrity checks may be implemented to protect the integrity and confidentiality of the biometric data of an avatar owner. Regular updates and maintenance may ensure an avatar remains current and accurate, reflecting any changes in the appearance or biometric characteristics of an avatar owner over time.

In some embodiments, avatar engine 230 may render an avatar by receiving or determining three-dimensional mesh data representing the basic geometry (e.g., structure, shape) of the avatar. Avatar engine 230 may process the three-dimensional mesh data by using graphical shaders (e.g., vertex shaders, pixel (or fragment) shaders, geometry shaders, tessellation shaders) to render a visually realistic or stylized image based on defined lighting and environmental effects.

In some embodiments, avatar engine 230 may include encoder-decoder tool 232, ray marching tool 234, and radiance field tool 236. Encoder-decoder tool 232 may collect one or more input images of a subject (e.g., a full-body or full-face portrait image of a subject, or multiple images of a body of a subject, or portions thereof, from different views) and extract features (e.g., pixel-aligned features) to condition radiance field tool 236 via a ray marching procedure in ray marching tool 234. In some embodiments, avatar engine 230 may generate novel views of unseen subjects from one or more sample images processed by encoder-decoder tool 232. In some embodiments, encoder-decoder tool 232 may include a shallow (e.g., including multiple one-or two-node layers) convolutional network. In some embodiments, radiance field tool 236 may convert a three-dimensional location and features into color and opacity fields that may be projected in any desired direction of view.

In some embodiments, avatar engine 230 may access one or more artificial intelligence (AI) models (e.g., machine learning (ML) models) stored in database 152. Database 152 may include training archives and other data files that may be used by avatar engine 230 in the training of an AI model, according to the input of a user through application 222. Moreover, in some embodiments, at least one or more training archives or AI models may be stored in any one of memories 220, and a user may access the at least one or more training archives or AI models through application 222.

Avatar engine 230 may include algorithms trained for the specific purposes of the engines and tools included herein. The algorithms may include artificial intelligence (AI) models or algorithms, such as machine learning (ML) models or algorithms, making use of any linear or non-linear algorithm, such as a neural network algorithm or a multivariate regression algorithm. In some embodiments, an ML model may include a neural network (NN), a convolutional neural network (CNN), a generative adversarial neural network (GAN), a deep reinforcement learning (DRL) algorithm, a deep recurrent neural network (DRNN), or a classic ML algorithm such as random forest, k-nearest neighbor (KNN) algorithm, k-means clustering algorithms, or any combination thereof. More generally, an ML model may include any ML model involving a training step and an optimization step. In some embodiments, database 152 may include a training archive to modify coefficients according to a desired outcome of an ML model. Accordingly, in some embodiments, avatar engine 230 may be configured to access training database 152 to retrieve documents and archives as inputs for an ML model. In some embodiments, avatar engine 230, the tools contained therein, and at least part of database 152 may be hosted in a different server that is accessible by server(s) 130 or client device(s) 110.

Draping engine 250 may be configured to leverage artificial intelligence (AI) techniques for real-time garment mesh generation, ensuring high-quality, realistic garment fitting that responds dynamically to various avatars and their unique body parameters. Draping engine 250 may implement batch processing to efficiently create and adapt garment meshes for a plurality of avatars simultaneously.

In some embodiments, an AI model of draping engine 250 may include one or more convolution layers that may extract features from input data using one or more convolutional neural networks (CNNs) to capture essential patterns and characteristics of the data. In some embodiments, an AI model may include one or more pooling layers to reduce dimensionality while retaining important features, improving computational efficiency. In some embodiments, the features may be fully connected to an output layer, allowing the model to learn complex relationships between input data and output data.

In some embodiments, draping engine 250 may divide a dataset into training sets, validation sets, and testing sets (e.g., 60 percent training, 20 percent validation, 20 percent testing). In some embodiments, draping engine 250 may normalize data for consistent input size or scale. In some embodiments, draping engine 250 may augment the dataset through techniques such as rotation, flipping, or color adjustment to improve generalization. In some embodiments, draping engine 250 may use an appropriate loss function (e.g., mean squared error (MSE)) to quantify the difference between predicted and known outputs. In some embodiments, draping engine 250 may implement an optimizer (e.g., stochastic gradient descent (SGD)) to adjust model weights during training to minimize the loss. In some embodiments, draping engine 250 may train the model over several epochs, monitoring the loss on the training and validation datasets to prevent overfitting. In some embodiments, after training, draping engine 250 may evaluate the model using the testing set to assess an accuracy or a performance of the AI model. In some aspects of the embodiments, draping engine 250 may use metrics such as root mean square error (RMSE) or mean absolute error (MAE) to evaluate the model. In some embodiments, once the AI model has achieved satisfactory accuracy, the AI model may be integrated into an application (e.g., application 222) for real-time generation of garment meshes for avatars.

In some embodiments, draping engine 250 may train and implement a plurality of AI models (e.g., ML models) for generating a digital representation for a physical object, given a shape and a pose of the physical object. In some embodiments, the one or more AI models may be trained offline. In some embodiments, the digital representation may include a mesh, the physical object may include a garment, and the shape and pose may include a shape and a pose of an individual wearing the garment. Each AI model of the plurality of AI models may take as input a series of images (or frames) capturing the individual wearing the garment, which may be labeled with a shape of the individual, a pose of the individual, and a type of the garment. The type of the garment may include physical parameters of the garment (e.g., size, weight, texture). In some aspects of the embodiments, each AI model of the plurality of AI models may take as input a body of an avatar, wherein a pose of the body of the avatar corresponds to the pose of the individual wearing the garment. Each AI model of the plurality of AI models may provide as output a three-dimensional (3D) mesh representing a structure, fit, draping, or movement of the type of garment for a given shape and pose of the individual wearing the garment. The 3D mesh may include a plurality of vertices including location coordinates of the garment with respect to the physical environment of the individual or with respect to a body of an avatar in an extended reality environment, wherein the body of the avatar corresponds to the body of the individual and a pose of the avatar corresponds to the pose of the individual.

Draping engine 250 may use the plurality of meshes predicted for physical garments as ground truth data that may be used as a benchmark to train and evaluate an AI model configured to determine, for a plurality of avatars, a garment mesh for each garment type of a plurality of garment types worn by the plurality of avatars. The AI model may take as input a shape embedding, a pose embedding, and a garment embedding. The shape embedding may include a vector representation of a plurality of shape parameters for a plurality of avatars. The pose embedding may include a vector representation of a plurality of pose parameters for a plurality of avatars. The garment embedding may include a vector representation of a plurality of garment parameters for a plurality of garment types.

In some embodiments, the AI model may include a neural network (NN), which may include one or more embedding layers. A garment embedding layer may translate discrete garment type categories into vector representations. For example, a vector representation may be a p-dimensional vector of floating-point values (e.g., [0.3, −0.9, 5.6], where p=3). In some embodiments, vector representations of different garment types may be a uniform dimension. In some aspects of the embodiments, the uniform dimension may be predefined. In other aspects of the embodiments, vector representations of different garment types may be different dimensions. In such aspects, one or more of the vector representations may be padded or truncated to change the dimensions of the vector representations to the uniform dimension. In such aspects, the uniform dimension may be predefined, or the uniform dimension may equal the dimension of the smallest or the largest vector representation. The translation of garment type categories into vector representations may enable the neural network to effectively learn the relationships between different garment types and corresponding mesh characteristics of the different garment types. In some embodiments, the input to the embedding layer may include discrete categories representing various garment types (e.g., shirts, pants, shoes, skirts). Each garment type may be encoded as an integer index. The output of the embedding layer may be a vector (e.g., a dense vector) for each input integer. The values (e.g., weights) of a vector may be learned during training of the neural network. A weight matrix of the embedding layer may store the vector representations for all possible garment types. The dimension of the weight matrix may be m×n, where m is the number of unique garment types, and n is the size of the embedding vectors. The weight matrix may be initialized with random values. When a garment type is fed into the embedding layer (e.g., an integer representing a garment type), the corresponding row from the weight matrix may be retrieved, wherein the row includes the vector representation of the garment type. A retrieved vector may be passed through subsequent layers of the neural network for further processing. During training, the values (i.e., weights) in the matrix may be updated based on gradients computed during backpropagation. Such adjustments may allow the neural network to learn more over time. During training of the neural network, the values in the weight matrix may be adjusted to minimize a loss function of the neural network, allowing both the weights of vector representations (i.e., embeddings) of garment types and other weights in the neural network to be learned. In some embodiments, the values in the weight matrix may represent the learned relationships between different garment types. For example, similar garment types may have similar vector representations, capturing a relationship between the vector representations in the embedding space.

In some embodiments, the AI model may implement a loss function to quantify the difference between the predicted garment meshes and the actual (e.g., ground truth) garment meshes. For example, a loss function may measure the distance between predicted and actual vertex positions of garment meshes. In some embodiments, the AI model may be trained offline. Once trained, the AI model may be loaded for real-time execution on a client device (e.g., a mixed reality headset).

In some embodiments, draping engine 250 may include shape determining tool 252, pose determining tool 254, and garment determining tool 256.

Shape determining tool 252 may be configured to analyze or extract shape parameters from an avatar, enabling the accurate representation of dimensions and proportions of the avatar. Shape determining tool 252 may collect various body measurements or characteristics from the avatar (e.g., height, build, silhouette, shoulder width, arm length, waist circumference, head circumference, gender). In some embodiments, shape determining tool 252 may process the body measurements to derive parameters such as proportions (e.g., shoulder-to-hip ratio, waist-to-hip ratio), curvatures (e.g., bust line, waistline, hips), or volume or surface area. In some embodiments, shape determining tool 252 may utilize algorithms to analyze and normalize the measurements, ensuring consistency across different avatars. Normalizing the measurements may include identifying common body shapes within a dataset to categorize avatars. In some embodiments, shape determining tool 252 may use machine learning (ML) models trained to predict missing measurements or infer shape parameters based on existing data.

Pose determining tool 254 may be configured to analyze and extract pose parameters from an avatar, enabling the accurate representation of avatar body positions and orientations. Pose determining tool 254 may collect various measurements or characteristics related to avatar pose (e.g., joint angles, such as shoulder, elbow, hip, knee; limb positioning, such as distance between hands and feet; or orientation of the head or torso). In some embodiments, pose determining tool 254 may process measurements to derive pose parameters such as joint positions (e.g., 3D coordinates of key joints in the avatar), angles between limbs (e.g., to provide insights into range of motion or flexibility), or spatial orientation (e.g., data about an orientation of an avatar in space, such as forward or backward tilt, side-to-side lean, or rotation). Pose determining tool 254 may utilize algorithms to analyze and normalize pose data, ensuring consistency across different avatars and poses. Normalizing pose data may include using hierarchical models to represent how movements of one joint affect others, maintaining realistic movement, or may include using a statistical model to analyze common poses to categorize and predict movements based on previous data.

Garment determining tool 256 may be configured to recognize, analyze, or extract garment parameters associated with an avatar, enabling accurate fitting, styling, or customization of garments based on a body shape or body pose of an avatar. Garment determining tool 256 may utilize computer vision techniques to analyze images or 3D models of an avatar to identify a type of garment worn by the avatar (e.g., shirts, pants, shoes, skirts). Garment determining tool 256 may identify specific features of a garment, such as patterns, colors, textures, or design elements (e.g., collars, cuffs, hemlines). Garment determining tool 256 may extract garment parameters from an identified garment, such as type or style (e.g., casual, formal, sportswear), size specifications (e.g., recommended sizes based on a body measurement of an avatar or a fit characteristic of an avatar), or fit type (e.g., loose, fitted, tailored). Garment determining tool 256 may determine or may receive data about a fabric type used in a garment, wherein a fabric type may influence a drape or fit of the garment. Fabric type data may include stretchability, drape quality (e.g., how the fabric hangs on the body, affected by weight or texture), or breathability or texture. In some embodiments, garment determining tool 256 may enable a user to manually adjust garment parameters or to provide feedback on identified garments or features thereof. For example, a user may specify preferences or suggest modifications to a garment based on fit and style.

In some embodiments, an extended reality (XR) environment (e.g., a business meeting in a virtual reality (VR) environment, a retail store in an augmented reality (AR) environment) may include a plurality of avatars. Each avatar may represent a user of a client device (e.g., a head-mounted display (HMD)) running an application that generates the XR environment. The client devices may be communicatively coupled via a network. The application may transmit through the network, to other client devices running the application, one or more shape parameters, one or more pose parameters, and one or more garment parameters associated with an avatar of a user of a client device. The application may generate a shape vector for the one or more shape parameters of the plurality of avatars. The application may generate a pose vector for the one or more pose parameters of the plurality of avatars. The application may generate a garment vector for the one or more garment parameters for the plurality of avatars. The garment vector may include a plurality of learned embeddings, wherein each learned embedding of the plurality of learned embeddings may correspond to a specific garment parameter (e.g., a garment category, such as t-shirt; a garment material, such as cotton) or a movement associated with the specific garment parameter. The shape vector, the pose vector, and the garment vector may be provided as an input to an AI model configured to determine, for a plurality of avatars, a garment mesh for each garment type of a plurality of garment types worn by the plurality of avatars.

Draping engine 250 may implement batch processing algorithms to enable an AI model to generate garment meshes for multiple avatars in a single computational pass, which may optimize processing time and resources. Using batch processing, a plurality of vectors (e.g., shape vector, pose vector, garment vector) may be provided as inputs to an AI model to predict a garment mesh. Using batch processing, the plurality of vectors may be processed by the AI model at the same time. In some embodiments, the plurality of vectors may be combined into a batch matrix (e.g., via concatenation, via multiplication). The batch matrix may be provided as input to an AI model to predict a garment mesh.

Rendering module 270 may be configured to convert a garment mesh into a visual representation. Rendering module 270 may allow the garment mesh to be visually integrated into a digital environment, such as an extended reality (XR) environment or interactive simulation. For an extended reality environment, rendering module 270 may use cameras or depth sensors of a client device to scan or map a real-world environment, allowing rendering module 270 to understand a physical space and to accurately place a digital garment defined by the garment mesh. To position the digital garment on an avatar, rendering module 270 may use pose data from motion capture or predefined animations to position the avatar in the digital environment. Rendering module 270 may ensure the digital garment fits the body dimensions or movements of an avatar, adjusting dynamically as the avatar moves. Rendering module 270 may utilize shaders to define how the digital garment interacts with light, affecting an appearance of the digital garment.

Rendering module 270 may render a garment mesh in real time to ensure responsiveness as a user interacts with a digital environment. To enable real-time rendering, rendering module 270 may implement level of detail (LOD) techniques to optimize rendering by selecting appropriate model detail, or rendering module 270 may implement culling techniques to render only parts of the garment that are visible to a user. To enhance realism, rendering module 270 may implement physics engines to simulate garment behavior, allowing a garment to drape and move naturally with the avatar. Physics engines may ensure a garment mesh interacts correctly with an avatar or a surrounding digital or real-world environment, and physics engines may model how a garment responds to movement, wind, or other environmental factors. Rendering module 270 may enable a user to interact with the garment through gestures or voice commands, triggering animations or changing garment styles in real time.

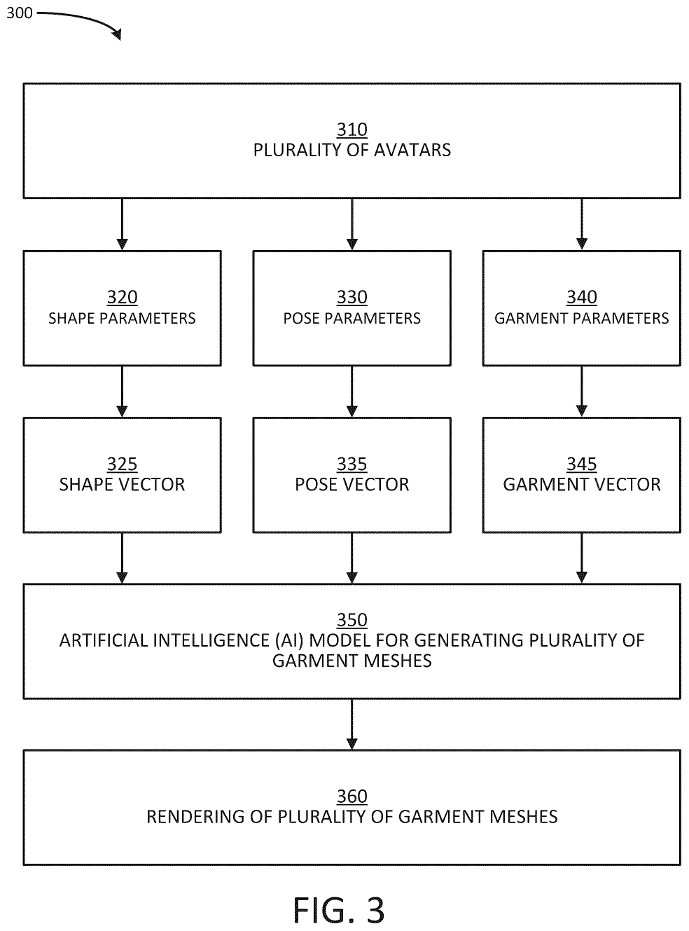

FIG. 3 is a block diagram illustrating example operational blocks 300 used in the example environment 100 of FIG. 1, according to some embodiments.

In Block 310, an extended reality (XR) environment (e.g., a business meeting in a virtual reality (VR) environment, a retail store in an augmented reality (AR) environment) may include a plurality of avatars. Each avatar may represent a user of a client device (e.g., a head-mounted display (HMD)) running an application that generates the XR environment. The client devices may be communicatively coupled via a network.

In Block 320, for each avatar, one or more shape parameters may be determined for each frame of the XR environment. A shape parameter may include a digital representation of an attribute that defines a form or structure of an avatar body (e.g., height, build, silhouette, proportion, head circumference, gender).

In Block 330, for each avatar, one or more pose parameters may be determined for each frame of the XR environment. A pose parameter may include a digital representation of a posture, stance, position, or movement of the avatar (e.g., sitting, walking, kneeling, bowing, nodding, waving). By way of non-limiting example, a pose parameter may include a positioning of the limbs of an avatar in a coordinate space (e.g., three-dimensional Cartesian coordinate system).

In Block 340, for each avatar, one or more garment parameters may be determined for each frame of the XR environment. A garment parameter may include a characteristic of a garment (e.g., category, material, condition, use). By way of non-limiting example, a garment parameter may include a category of a garment indicative of a purpose (e.g., modesty, protection, safety), occasion (e.g., formal, casual, graduation, wedding), or intended body part (e.g., t-shirt, blouse, blazer, jeans, skirt, tunic, cloak, head scarf, veil, hat, sneakers) of the garment. By way of another non-limiting example, a garment parameter may include a material of a garment (e.g., silk, cashmere, nylon, acrylic, velvet, denim, metal, plastic). By way of yet another non-limiting example, a garment parameter may include a condition of a garment (e.g., new, unworn, starched, wrinkled, frayed, faded, stained, warped). By way of yet another non-limiting example, a garment parameter may include a physical property of a garment (e.g., weight, stiffness, or elasticity of a fabric or a material of a garment).

The application may transmit through the network one or more shape parameters, one or more pose parameters, and one or more garment parameters associated with an avatar of a user of a client device.

In Block 325, at a client device, the application may generate a shape vector for the one or more shape parameters of the plurality of avatars.

In Block 335, at a client device, the application may generate a pose vector for the one or more pose parameters of the plurality of avatars.

In Block 345, at a client device, the application may generate a garment vector for the one or more garment parameters for the plurality of avatars. The garment vector may include a plurality of learned embeddings, wherein each learned embedding of the plurality of learned embeddings may correspond to a specific garment parameter (e.g., a garment category, such as t-shirt; a garment material, such as cotton) or a movement associated with the specific garment parameter. In some aspects of the embodiments, the learned embeddings may be received from an auxiliary model pretrained offline. In some aspects of the embodiments, the embeddings may be learned from physical simulation data that may define the movement of a garment type. In some further aspects of the embodiments, the physical simulation data may include one or more pretrained models. The one or more pretrained models used to learn an embedding of a garment type may further include a first pretrained model that provides data based on a category, style, or design of a garment (e.g., pants, shirt, jacket, shoes, tie, scarf), and a second pretrained model may provide data based on a material of the garment (e.g., denim pants, silk shirt, leather jacket, canvas shoes, silk tie, cashmere scarf). Other pretrained models may be considered that may provide additional data, such as velocity or acceleration data, to further enhance the embedding of the garment type, potentially operating in concert with a shape vector or a pose vector.

The application may provide, at inference, the shape, pose, and garment vectors as inputs to an artificial intelligence (AI) model (e.g., a machine learning (ML) model, such as a neural network) executing on a client device.

In Block 350, the AI model may be configured to determine a garment mesh for each garment type of a plurality of garment types. For each garment type of an avatar, the AI model may determine as output a mesh, which may include a geometric three-dimensional representation of a garment. The mesh may include a plurality of vertices, edges, surfaces, or textures, which may be located in a space comprising the XR environment. In some aspects of the embodiments, a predicted mesh may be optimized by comparing the predicted mesh representing the movement of the garment on the avatar to the actual movement of the garment based on a movement of the garment that has been previously calculated. The previous calculation may come from previously stored data or from data used to train the AI model.

Batch processing may enable the AI model to generate garment meshes for multiple avatars in a single computational pass, which may optimize processing time and resources. Using batch processing, a plurality of vectors (e.g., shape vector, pose vector, garment vector) may be provided as inputs to the AI model to predict a garment mesh. Using batch processing, the plurality of vectors may be processed by the AI model at the same time. In some embodiments, the plurality of vectors may be combined into a batch matrix (e.g., via concatenation, via multiplication). The batch matrix may be provided as input to the AI model to predict a garment mesh.

In Block 360, for each avatar, the application may render a plurality of garment meshes in the XR environment and may apply to each avatar of the plurality of avatars each garment mesh generated for the avatar.

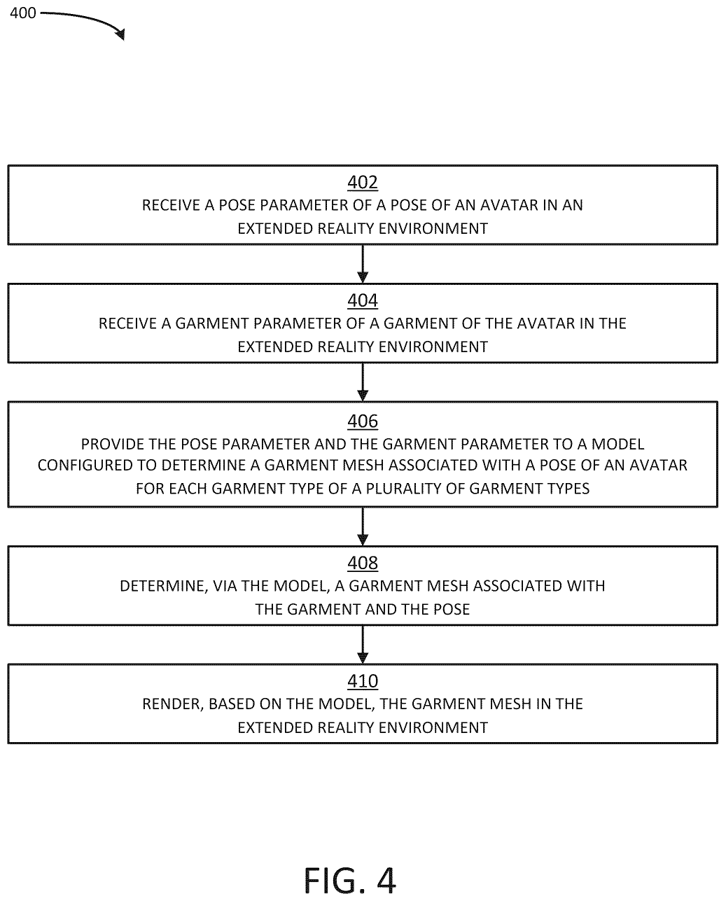

FIG. 4 includes a flowchart illustrating operations in a method 400 for determining a garment mesh for an avatar, according to some embodiments. In some embodiments, processes as disclosed herein may include one or more operations in method 400 performed by a processor circuit executing instructions stored in a memory circuit, in a client device, a remote server or a database, communicatively coupled through a network (e.g., processors 212, memories 220, client device(s) 110, server(s) 130, database 152, and network 150). In some embodiments, one or more of the operations in method 400 may be performed by an avatar engine—which may include an encoder-decoder tool, a ray marching tool, or a radiance field tool—a draping engine—which may include a shape determining tool, a pose determining tool, or a garment determining tool—or a rendering module (e.g., avatar engine 230, encoder-decoder tool 232, ray marching tool 234, radiance field tool 236, draping engine 250, shape determining tool 252, pose determining tool 254, garment determining tool 256, or rendering module 270). In some embodiments, processes consistent with the present disclosure may include at least one or more operations as in method 400 performed in a different order, simultaneously, quasi-simultaneously, or overlapping in time.

Operation 402 may include receiving a pose parameter of a pose of an avatar in an extended reality environment. In some embodiments, the avatar may include a plurality of avatars. In some aspects of the embodiments, the pose may include at least one pose associated with each avatar of a plurality of avatars. In some embodiments, receiving the pose parameter of the pose of the avatar may include receiving a location of the avatar or a portion of the avatar in a coordinate system of the extended reality environment.

Operation 404 may include receiving a garment parameter of a garment of the avatar in the extended reality environment. In some embodiments, the avatar may include a plurality of avatars. In some aspects of the embodiments, the garment may include at least one garment associated with each avatar of the plurality of avatars. In some embodiments, receiving the garment parameter of the garment of the avatar may include receiving pretrained data associated with the garment from an offline model.

Operation 406 may include providing the pose parameter and the garment parameter to a model configured to determine a garment mesh associated with a pose of an avatar for each garment type of a plurality of garment types. In some embodiments, the model may include a neural network (NN). In some embodiments, the model may be optimized by comparing a first output received from the model with a second output received from a pretrained offline model. In further aspects of the embodiments, Operation 406 may include receiving a shape parameter of a shape of the avatar in the extended reality environment, wherein the shape parameter may define a form or a structure of a body of the avatar. In some further aspects of the embodiments, the avatar may include a plurality of avatars. In some further aspects of the embodiments, the shape may include at least one shape of each avatar of the plurality of avatars. In further aspects of the embodiments, Operation 406 may include providing the shape parameter to the model.

Operation 408 may include determining, via the model, a garment mesh associated with the garment and the pose. In some embodiments, the garment mesh may include a plurality of vertices including location coordinates of the garment of the avatar in the extended reality environment. In some embodiments, determining the garment mesh associated with the garment and the pose may include determining a displacement of a garment vertex of the plurality of garment vertices with respect to a body vertex of a plurality of body vertices including location coordinates of a body of the avatar in the extended reality environment.

Operation 410 may include rendering, based on the model, the garment mesh in the extended reality environment.

### Hardware Overview

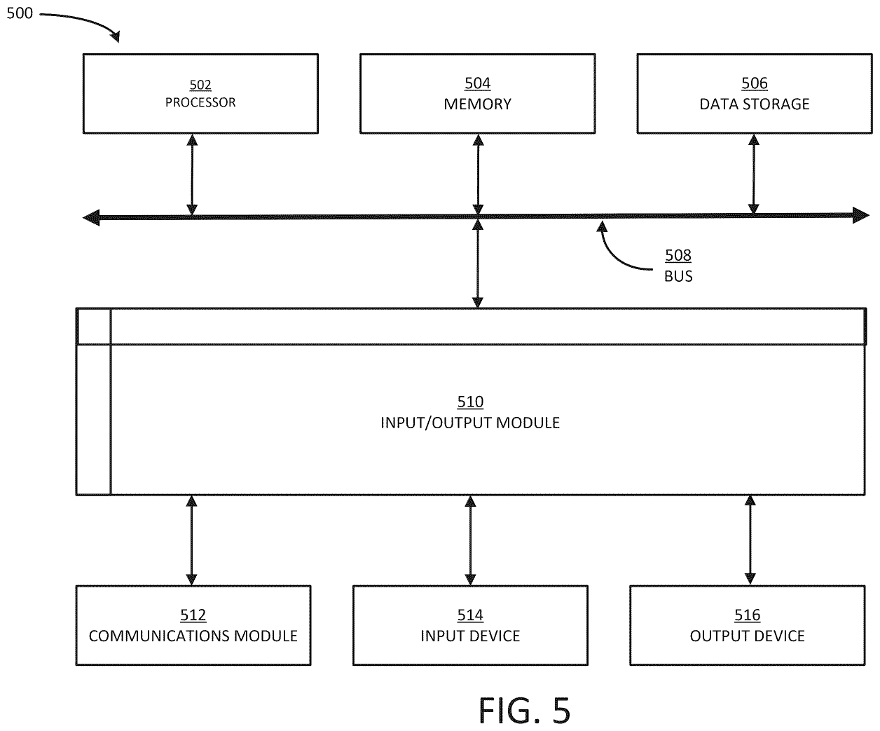

FIG. 5 is a block diagram illustrating an exemplary computer system 500 with which client devices, and the operations and methods in FIGS. 3 and 4, may be implemented, according to some embodiments. In certain aspects, the computer system 500 may be implemented using hardware or a combination of software and hardware, either in a dedicated server, or integrated into another entity, or distributed across multiple entities.

Computer system 500 (e.g., client device(s) 110 and server(s) 130) may include bus 508 or another communication mechanism for communicating information, and a processor 502 (e.g., processors 212) coupled with bus 508 for processing information. By way of example, computer system 500 may be implemented with one or more processors 502. Processor 502 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that may perform calculations or other manipulations of information.

Computer system 500 may include, in addition to hardware, code that creates an execution environment for the computer program in question, e.g., code that constitutes processor firmware, a protocol stack, a database management system, an operating system, or a combination of one or more of them stored in an included memory 504 (e.g., memories 220), such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 508 for storing information and instructions to be executed by processor 502. Processor 502 and the memory 504 may be supplemented by, or incorporated in, special purpose logic circuitry.

The instructions may be stored in memory 504 and implemented in one or more computer program products, e.g., one or more modules of computer program instructions encoded on a computer-readable medium for execution by, or to control the operation of, computer system 500, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 504 may also be used for storing temporary variable or other intermediate information during execution of instructions to be executed by processor 502.

A computer program as discussed herein does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one computer or on multiple computers that may be located at one site or distributed across multiple sites and interconnected by a communication network. The processes and logic flows described in this specification may be performed by one or more programmable processors executing one or more computer programs to perform functions by operating on input data and generating output.

Computer system 500 further includes a data storage device 506 such as a magnetic disk or optical disk, coupled to bus 508 for storing information and instructions. Computer system 500 may be coupled via input/output module 510 to various devices. Input/output module 510 may be any input/output module. Exemplary input/output modules 510 include data ports such as Universal Serial Bus (USB) ports. The input/output module 510 may be configured to connect to a communications module 512. Exemplary communications modules 512 (e.g., communications modules 218) include networking interface cards, such as Ethernet cards and modems. In certain aspects, input/output module 510 may be configured to connect to a plurality of devices, such as an input device 514 (e.g., input device 214) and/or an output device 516 (e.g., output device 216). Exemplary input devices 514 include a keyboard and a pointing device, e.g., a mouse or a trackball, by which a user may provide input to computer system 500. Other kinds of input devices 514 may be used to provide for interaction with a user as well, such as a tactile input device, visual input device, audio input device, or brain-computer interface device. For example, feedback provided to the user may be any form of sensory feedback, e.g., visual feedback, auditory feedback, or tactile feedback; and input from the user may be received in any form, including acoustic, speech, tactile, or brain wave input. Exemplary output devices 516 include display devices, such as an LCD (liquid crystal display) monitor, for displaying information to the user.

According to one aspect of the present disclosure, client device(s) 110 and server(s) 130 may be implemented using computer system 500 in response to processor 502 executing one or more sequences of one or more instructions contained in memory 504. Such instructions may be read into memory 504 from another machine-readable medium, such as data storage device 506. Execution of the sequences of instructions contained in memory 504 causes processor 502 to perform the process steps described herein. One or more processors in a multi-processing arrangement may also be employed to execute the sequences of instructions contained in memory 504. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification may be implemented in a computing system that includes a back-end component, e.g., a data server, or that includes a middleware component, e.g., an application server, or that includes a front-end component, e.g., a client computer having a graphical user interface or a Web browser through which a user may interact with an implementation of the subject matter described in this specification, or any combination of one or more such back-end, middleware, or front-end components. The components of the system may be interconnected by any form or medium of digital data communication, e.g., a communication network. The communication network (e.g., network 150) may include, for example, any one or more of a LAN, a WAN, the Internet, and the like. Further, the communication network may include, but is not limited to, for example, any one or more of the following tool topologies, including a bus network, a star network, a ring network, a mesh network, a star-bus network, tree or hierarchical network, or the like. The communications modules may be, for example, modems or Ethernet cards.

Computer system 500 may include clients and servers. A client and server may be generally remote from each other and typically interact through a communication network. The relationship of client and server arises by virtue of computer programs running on the respective computers and having a client-server relationship to each other. Computer system 500 may be, for example, and without limitation, a desktop computer, laptop computer, or tablet computer. Computer system 500 may also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 502 for execution. Such a medium may take many forms, including, but not limited to, non-volatile media, volatile media, and transmission media. Non-volatile media include, for example, optical or magnetic disks, such as data storage device 506. Volatile media include dynamic memory, such as memory 504. Transmission media include coaxial cables, copper wire, and fiber optics, including the wires forming bus 508. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer may read. The machine-readable storage medium may be a machine-readable storage device, a machine-readable storage substrate, a memory device, a composition of matter affecting a machine-readable propagated signal, or a combination of one or more of them.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

### General Notes on Terminology

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No clause element is to be construed under the provisions of 35 U.S.C. §112, sixth paragraph, unless the element is expressly recited using the phrase “means for” or, in the case of a method clause, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

The subject matter of this specification has been described in terms of particular aspects, but other aspects may be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims may be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems may generally be integrated together in a single software product or packaged into multiple software products. Other variations are within the scope of the following claims.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the clauses that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user. Method clauses may be provided to present elements of the various steps, operations, or processes in a sample order, and are not meant to be limited to the specific order or hierarchy presented.

Although illustrative embodiments have been shown and described, a wide range of modification, change, and substitution are contemplated in the foregoing disclosure and in some instances, some features of the embodiments may be employed without a corresponding use of other features. Those of ordinary skill in the art would recognize many variations, alternatives, and modifications. Thus, the scope of the invention should be limited only by the following claims, and it is appropriate that the claims be construed broadly and in a manner consistent with the scope of the embodiments disclosed herein.

What is claimed is:

1. A computer-implemented method for determining a garment mesh for an avatar, comprising:
receiving a pose parameter of a pose of an avatar in an extended reality environment;
receiving a garment parameter of a garment of the avatar in the extended reality environment;
providing the pose parameter and the garment parameter to a model configured to determine a garment mesh associated with a pose of an avatar for each garment type of a plurality of garment types; and
determining, via the model, a garment mesh associated with the garment and the pose.

2. The computer-implemented method of claim 1, wherein:
the avatar includes a plurality of avatars;
the pose includes at least one pose of each avatar of the plurality of avatars; and
the garment includes at least one garment associated with each avatar of the plurality of avatars.

3. The computer-implemented method of claim 1, further comprising receiving a shape parameter of a shape of the avatar in the extended reality environment, wherein the shape parameter defines a form or a structure of a body of the avatar.

4. The computer-implemented method of claim 1, wherein receiving the pose parameter of the pose of the avatar includes receiving a location of a portion of the avatar in a coordinate system of the extended reality environment.

5. The computer-implemented method of claim 1, wherein receiving the garment parameter of the garment of the avatar includes receiving pretrained data associated with the garment from an offline model.

6. The computer-implemented method of claim 1, wherein the model includes a neural network (NN).

7. The computer-implemented method of claim 1, wherein the model is optimized by comparing a first output received from the model with a second output received from a pretrained offline model.

8. The computer-implemented method of claim 1, wherein the garment mesh includes a plurality of garment vertices including first location coordinates of the garment of the avatar in the extended reality environment.

9. The computer-implemented method of claim 8, wherein determining the garment mesh associated with the garment and the pose includes determining a displacement of a garment vertex of the plurality of garment vertices with respect to a body vertex of a plurality of body vertices including second location coordinates of a body of the avatar in the extended reality environment.

10. The computer-implemented method of claim 1, further comprising rendering, based on the model, the garment mesh in the extended reality environment.

11. A system, comprising:
one or more processors; and
a memory storing instructions that, when executed by the one or more processors, cause the system to perform operations including:
receiving a pose parameter of a pose of an avatar in an extended reality environment;
receiving a garment parameter of a garment of the avatar in the extended reality environment;
providing the pose parameter and the garment parameter to a model configured to determine a garment mesh associated with a pose of an avatar for each garment type of a plurality of garment types; and
determining, via the model, a garment mesh associated with the garment and the pose.

12. The system of claim 11, wherein:
the avatar includes a plurality of avatars;
the pose includes at least one pose of each avatar of the plurality of avatars; and
the garment includes at least one garment associated with each avatar of the plurality of avatars.

13. The system of claim 11, wherein the operations further comprise:
receiving a shape parameter of a shape of the avatar in the extended reality environment, wherein the shape parameter defines a form or a structure of a body of the avatar.

14. The system of claim 11, wherein receiving the pose parameter of the pose of the avatar includes receiving a location of a portion of the avatar in a coordinate system of the extended reality environment.

15. The system of claim 11, wherein receiving the garment parameter of the garment of the avatar includes receiving pretrained data associated with the garment from an offline model.

16. The system of claim 11, wherein the model includes a neural network (NN).

17. The system of claim 11, wherein the model is optimized by comparing a first output received from the model with a second output received from a pretrained offline model.

18. The system of claim 11, wherein:
the garment mesh includes a plurality of garment vertices including first location coordinates of the garment of the avatar in the extended reality environment; and
determining the garment mesh associated with the garment and the pose includes determining a displacement of a garment vertex of the plurality of garment vertices with respect to a body vertex of a plurality of body vertices including second location coordinates of a body of the avatar in the extended reality environment.

19. The system of claim 11, wherein the operations further comprise rendering, based on the model, the garment mesh in the extended reality environment.

20. A non-transitory computer-readable storage medium storing instructions encoded thereon that, when executed by a processor, cause the processor to perform operations comprising:
receiving a pose parameter of a pose of an avatar in an extended reality environment;
receiving a garment parameter of a garment of the avatar in the extended reality environment, wherein receiving the garment parameter includes receiving pretrained data associated with the garment from an offline model;
providing the pose parameter and the garment parameter to a model configured to determine a garment mesh associated with a pose of an avatar for each garment type of a plurality of garment types;
determining, via the model, a garment mesh associated with the garment and the pose, wherein the garment mesh includes a plurality of garment vertices including first location coordinates of the garment of the avatar in the extended reality environment, and wherein determining the garment mesh associated with the garment and the pose includes determining a displacement of a garment vertex of the plurality of garment vertices with respect to a body vertex of a plurality of body vertices including second location coordinates of a body of the avatar in the extended reality environment; and
rendering, based on the model, the garment mesh in the extended reality environment.
